(19) United States
(12) Patent Application Publication
(10) Pub. No.: US 2019/0049361 A1
(43) Pub. Date: Feb. 14, 2019

(54) METHOD FOR MONITORING DEPOSITION IN WELLS, FLOWLINES, PROCESSING EQUIPMENT AND LABORATORY TESTING APPARATUS

(71) Applicant: Baker Hughes, a GE company, LLC, Houston, TX (US)

(72) Inventors: David Wayne Jennings, Houston, TX (US); Michael J. Deighton, Fulshear, TX (US); Brian B. Ochoa, Hannover (DE); Tudor C. Ionescu, Houston, TX (US)

(73) Assignee: Baker Hughes, a GE company, LLC, Houston, TX (US)

(21) Appl. No.: 16/052,993

(22) Filed: Aug. 2, 2018

Related U.S. Application Data
(60) Provisional application No. 62/543,617, filed on Aug. 10, 2017.

(51) Int. Cl. G01N 17/00; E21B 47/00; G01N 19/00; G01V 9/00

(52) U.S. Cl. CPC G01N 17/008; G01V 9/00; G01N 19/00; E21B 47/00

(57) ABSTRACT

A method for measuring chemical species deposition in a well, flow line, or processing equipment includes monitoring a resonator sensor in a well, flow line, or processing equipment having a fluid flowing therethrough, where the resonator sensor can be a torsional resonator or a symmetrical sensor, and the method also includes detecting a change in resonance of the resonator sensor indicating the deposition of a chemical species on the resonator sensor. The resonator sensor can also measure the amount of chemical species deposited. The fluid may be an organic and/or aqueous fluid that comprises petroleum and/or produced water and the deposition chemical species include, but are not necessarily limited to, asphaltenes, wax, scale, gas hydrates, naphthenic acid salts, and combinations thereof.

### CROSS-REFERENCE TO RELATED APPLICATION

This application claims the benefit of U.S. Provisional Application No. 62/543,617 filed Aug. 10, 2017, incorporated herein by reference in its entirety.

### TECHNICAL FIELD

The present invention relates to methods for detecting the deposition of chemical species in a well, flowline, or processing equipment, and more particularly relates in one non-limiting embodiment to methods for detecting the presence of and/or measurement of the relative rates of amounts of chemical species depositing in a well, flowline, or processing equipment having petroleum-based and/or aqueous-based fluids flowing therethrough.

### BACKGROUND

Various types of foulants, contaminants and chemical species pose problems during production and refining of hydrocarbon fluids. Foulants are materials within production fluids or refinery streams that may become destabilized and deposit on equipment, which can cause problems with the fluid during extraction, transporting, processing, refining, combustion, and the like. Examples of foulants of concern include, but are not necessarily limited to, asphaltenes, waxes, scale, gas hydrates, naphthenates, naphthenic acid salts, iron sulfide, coke, and the like.

For the purposes herein, production fluids or formation fluids are the products from a reservoir at the time the fluids are produced. Production fluids consist of petroleum hydrocarbon liquids, gases, and produced water. The petroleum hydrocarbon liquids contain a large number of components with very complex compositions. Some of the potentially fouling-causing components present in the petroleum fluids, for example wax and asphaltenes, are generally stable in the crude oil under equilibrium reservoir conditions, but may precipitate and deposit as temperatures, pressures, and overall fluid compositions change as the crude oil is removed from the reservoir during production. Waxes comprise predominantly high molecular weight paraffinic hydrocarbons, i.e. alkanes. Asphaltenes are typically dark brown to black-colored amorphous solids with complex structures and relatively high molecular weights. The produced water consists of brine solutions containing ions from various salts, such as, but not limited to, Na⁺, K⁺, Ca⁺², Ba⁺², Sr⁺², Mg⁺², Si⁺², Fe⁺², Cl⁻, HCO⁻³, and SO₄⁻². The potentially fouling-causing scale from the produced water, for example CaCO₃, BaSO₄, and CaSO₄, are generally stable in the produced water under equilibrium reservoir conditions, but may precipitate and deposit as temperatures, pressures, and overall fluid compositions change as the produced water is removed from the reservoir during production.

Asphaltenes are most commonly defined as that portion of petroleum, which is insoluble in heptane. Asphaltenes exist in crude oil as both soluble species and in the form of colloidal dispersions stabilized by other components in the crude oil. Asphaltenes may include a distribution of thousands of chemical species having chemical similarities, although they are by no means nearly all identical. In general, asphaltenes have higher molecular weights and are the more polar fractions of crude oil, and can precipitate upon pressure, temperature, and compositional changes in crude oil resulting from production, blending, or other mechanical or physicochemical processing. CO₂ flooding, gas injection, and commingling heavy crude oils with light crude oils or condensates during production are common blending operations which can cause asphaltene destabilization. Asphaltene precipitation and deposition can cause problems in subterranean reservoirs, upstream production facilities, mid-stream transportation facilities, refineries, and fuel blending operations. In petroleum production facilities, asphaltene precipitation and deposition can occur in near-wellbore reservoir regions, wells, flowlines, separators, and other equipment. Once deposited, asphaltenes present numerous problems for crude oil producers. For example, asphaltene deposits can plug downhole tubulars, wellbores, choke off pipes and interfere with the functioning of safety shut-off valves, and separator equipment. Asphaltenes have caused problems in refinery processes such as desalters, distillation preheat units, and cokers.

The waxes or paraffins in petroleum are primarily from alkanes—both normal and branched species. Normal alkanes comprise the majority of waxes in most crude oils. The longer the chain length of the wax, the more limited the solubility of the wax in crude oil, petroleum, and solvents. N-alkane chain lengths up to 100 carbons have been detected in crude oil. The wax appearance temperature is the temperature at which the first amount of wax starts to precipitate from a crude oil. Wax will deposit from a crude oil in well tubing, flowlines, or processing equipment if the inner surface temperature of the well tubing, flowlines, or processing equipment is below the crude oil wax appearance temperature and a temperature gradient exists between the bulk crude oil temperature and the colder surface temperature. Wax deposition is common in many petroleum production facilities especially in operations in cold environments thereby requiring methods to manage the deposition. Wax deposition management strategies include both preventative and remediation methods. Preventative methods include using active heating and insulation to keep flow streams warm; that is, above wax appearance temperatures. Remediation methods include operations such as pigging in flow lines and wireline cutting in well tubulars. Use of other management means such as application of chemical paraffin inhibitors are also used to reduce the amount of wax depositing.

When the formation fluid from a subsurface formation comes into contact with a pipe, a valve, or other production equipment of a wellbore, or when there is a decrease in temperature, pressure, or change of other conditions, foulants may precipitate or separate out of a well stream or the formation fluid, while the formation fluid is flowing into and through the wellbore to the wellhead. While any foulant separation or precipitation is undesirable in and by itself, it is much worse to allow the foulant precipitants to deposit or accumulate on equipment in the wellbore. Any foulant precipitant depositing on wellbore surfaces may narrow pipes and clog wellbore perforations, flow valves, and other well site and downhole locations. This may result in well site equipment failures and/or closure of a well. It may also slow down, reduce or even totally prevent the flow of formation fluid into the wellbore and/or out of the wellhead. Similarly, undetected precipitation and deposition of foulants in a pipeline for transferring crude oil could result in loss of crude oil flow.

Similarly, in refineries precipitation of species can foul or cause adverse effects in equipment ranging from the initial desalters through the various refinery reactors conversion units. For example, precipitated asphaltene species are the initial precursors to coke formation in the refinery on heat exchangers, reactors, and reactor catalysts. This coke formation can cause the various refinery process equipment to be shut-down for cleaning thereby incurring maintenance cost and reduce refining throughput. In addition, coke formation insulates surfaces leading to a reduction in heat transfer and an increase in energy costs to the refiner. After crude oil costs, energy costs are the second highest direct cost to refiners.

Accordingly, there are large incentives to mitigate fouling during production and refining of petroleum. There are large costs associated with shutting down production and refining units because of the fouling components within, as well as the cost to clean the units. In either case, reducing the amount of fouling would reduce the cost to produce hydrocarbon fluids and the products derived therefrom.

One technique to reduce the adverse effects of foulants within the formation fluids is to add foulant inhibitors to the fluids having potential fouling causing components. A “foulant inhibitor” is defined herein to mean an inhibitor that targets a specific foulant. Several foulant inhibitors may be added to reduce the adverse effects of each type of foulant, e.g. asphaltene foulant inhibitors, paraffin foulant inhibitors, and calcium carbonate foulant inhibitors all may be added to the fluid to decrease the adverse effects of each type of foulant, such as deposition, accumulation, and/or agglomeration of the foulant(s). However, it is often difficult to determine the extent of fouling that is occurring until severe fouling and deposition problems are present, or to determine the potential effectiveness of treatment programs such using foulant inhibitors.

Thus, it would be desirable to have better methods to detect and monitor fouling occurring within wells, flowlines, or processing equipment.

### SUMMARY

There is provided, in one form, a method for measuring chemical species deposition in a well, flow line, and/or processing equipment that includes monitoring a resonator sensor in a well, flow line, or processing equipment having an organic and/or aqueous fluid flowing therethrough, where the resonator sensor is selected from the group consisting of a torsional resonator or a symmetrical sensor, and detecting a change in resonance of the resonator sensor indicating the deposition of a chemical species on the resonator sensor.

### BRIEF DESCRIPTION OF THE DRAWINGS

FIG. 1 is a graph of temperature, viscosity and density over time for a wax-like polymer solution fluid under static conditions;

FIG. 2 is a graph of temperature, viscosity and density over time for the wax-like polymer solution fluid of FIG. 1 under flowing conditions; and

FIG. 3 is a graph of temperature, viscosity and density over time for a wax-like polymer solution fluid different from that of FIGS. 1 and 2 under flowing conditions.

FIG. 4 is a schematic diagram of an apparatus to measure asphaltene deposition from dead crude oils caused by addition of a destabilizing solvent;

FIG. 5 is a photograph of asphaltene deposits on an inner rod deposition chamber viewed at 0°;

FIG. 6 is a photograph of asphaltene deposits on the inner rod deposition chamber of FIG. 5 viewed at 90°;

FIG. 7 is a photograph of asphaltene deposits on the inner rod deposition chamber of FIG. 5 viewed at 180°;

FIG. 8 is a photograph of asphaltene deposits on the inner rod deposition chamber of FIG. 5 viewed at 270°;

FIG. 9 is a photograph of asphaltene deposits formed on the sensor and shaft of the torsional resonator viscosity-density sensor viewed from the front flow path;

FIG. 10 is a photograph of asphaltene deposits formed on the sensor and shaft of the torsional resonator viscosity-density sensor viewed from the backside of the flow path, showing less deposition;

FIG. 11 is a graph of viscosity as a function of time for the torsional resonator viscosity-density sensor of Example 3 illustrating that the viscosity profile steadily increases with asphaltene deposition; and

FIG. 12 is a graph of density as a function of time for the torsional resonator viscosity-density sensor of Example 3 illustrating that the density profile steadily was relatively steady during the test.

### DETAILED DESCRIPTION

A method has been discovered for measuring the deposition of chemical species in a well, flow line, or processing equipment. It will be appreciated that in the context herein, “well” is defined to include a well in a subterranean formation for the production of hydrocarbons including but not necessarily limited to, oil and gas, particularly petroleum, although the methods herein could be applicable to water wells. “Flow lines” in the context herein are defined to include upstream, mid-stream and downstream flow lines, conduits, and pipes in hydrocarbon recovery and processing including, but are not necessarily limited to, blending in pipeline operations, terminals, marine fuels, refinery storage tanks, etc., as well as in the qualification of finished fuels including, but not necessarily limited to, diesel fuel. “Flow lines” also include those lines used in the manufacture of polymers and other materials, and in any laboratory testing and processing apparatus where deposition of a chemical species is of a concern. In addition, in the manufacture of polymers, the methods described herein can be used to measure viscosity as a quality control parameter of the product polymer. In another process application, the ability to adjust or use the proper amount of caustic or other component could be handled or monitored by online density measurements.

In another non-limiting embodiment, the method may be practiced in the presence of other chemicals or materials found in subterranean reservoirs, upstream production facilities, mid-stream transportation facilities, refining operations, and fuel blending operations. These chemicals and/or materials include, but are not limited to, water, brine, surfactants, acids, inorganic scale, formation sand, formation clays, corrosion by-products, upstream petroleum production chemicals, and refinery processing chemicals. These chemicals may or may not affect the foulant stability, foulant deposition, and/or foulant inhibitor efficacy.

The petroleum-based fluid may be or include at least one fluid, such as but not limited to, a production fluid, crude oil, natural gas condensate, shale oil, shale gas condensate, bitumen, diluted bitumen (dil-bit), refinery fractions, finished fuel, finished petroleum products, and combinations thereof. In a non-limiting embodiment, the petroleum-based fluid sample may be only one fluid where determining the deposition of foulants in the at least one fluid may be desired. In an alternative embodiment, the petroleum fluid may be a mixture of at least two fluids to determine how one fluid may affect the deposition of foulants within another fluid. As noted, sometimes while two different fluids individually may not have fouling problems, fouling may occur and/or chemical species may be deposited after the two fluids are mixed.

As chemical species in a flowing fluid, e.g. asphaltenes in an organic fluid such as petroleum, are destabilized and flocculated, it has been discovered that they deposit on a resonator sensor placed in the flow line or well through which the organic fluid is flowing. Suitable resonator sensors include but are not necessarily limited to a torsional resonator or a symmetrical sensor. In one non-limiting embodiment herein, the term “resonator sensor” does not encompass quartz crystal microbalances (QCMs), also known as quartz crystal resonators; that is, there is an absence of a QCM in the methods described herein. The measurement principle of the resonator sensors herein differs from that of QCMs. In the resonator sensors herein, the damping measurement of the system is based on the change of phase around this resonance frequency.

The changes encountered by the chemical species in the organic fluid may be related to the separation or stability of foulant species, foulant species treated with inhibitors, or both. Typically, as chemical species precipitate and/or separate at or near the surface, they tend to form deposits, and when the deposits occur on a resonator sensor and its resonance is changed, the presence of the deposition of chemical species is detected. The change in resonance of the resonator sensor is a change including, but not necessarily limited to, a viscosity change, density change, and/or deposition build-up on the sensor. In the embodiment where the amount of change in resonance is detected over a time period related to deposition build-up it may be correlated to the amount of deposition of the chemical species on the resonator sensor, thus not only the presence but the amount of the chemical species depositing may potentially be measured.

Analysis testing of aqueous and/or petroleum-based fluid samples with foulant inhibitors may be used to gauge the efficacy of the foulant inhibitors to reduce deposition from foulants in petroleum-based fluids. “Foulant inhibitor” is defined herein to mean a chemical product which inhibits or reduces deposition of a particular foulant. The mechanism of action of the foulant inhibitor can work in multiple manners including, but not limited to, keeping a foulant soluble or remaining in a dispersed form within the petroleum-based fluid sample such that it cannot deposit, or reducing the rate the foulant deposition, or reducing the ability of the foulant to adhere or remain adhered to surfaces. The methods and apparatus described herein may be used to determine the presence and potential rate of deposition of a foulant and help determine how effective a particular foulant inhibitor is performing, whether the amount of foulant inhibitor should be increased or decreased, and/or whether a foulant inhibitor is to be introduced at all.

In one non-limiting embodiment the method described herein may involve monitoring the resonance of the sensor for just detecting whether deposition is occurring and determining the location of deposition in wells or flowlines through the use of multiple sensors placed in different locations. Such information, in itself, is valuable towards understanding and optimizing operation of production and refining facilities.

In a second non-limiting embodiment the method described herein may involve monitoring the resonator sensor at a first time where the organic fluid has an absence of a foulant inhibitor to give a first measurement, monitoring the resonator sensor at a subsequent, second time where the organic fluid comprises a foulant inhibitor to give a second measurement, and then comparing the first measurement and the second measurement to determine the effectiveness of the foulant inhibitor. If there is essentially no difference between the first measurement and the second measurement, then the foulant inhibitor can be considered ineffective for the particular organic fluid and/or the conditions. However, if the second measurement indicates that there is less chemical species deposition on the resonator sensor than the first measurement indicates, then the foulant inhibitor can be considered effective. Additionally, while complete prevention of the chemical species from depositing or precipitating on the resonator sensor is certainly a goal, the foulant inhibitor may be considered effective if the amount of chemical species deposition is reduced or inhibited as compared to the case where no foulant inhibitor is used.

In the case where the flowing fluid is an organic fluid, in one non-limiting embodiment the fluid comprises petroleum and the foulant chemical species include but are not necessarily limited to, asphaltenes, wax, scale, gas hydrates, naphthenic acid salts, iron sulfide, coke, and combinations thereof.

In one non-limiting embodiment the method further includes subsequently removing the chemical species from the resonator sensor, that is, a goal is for the resonator sensor to be easily cleaned periodically so that baseline readings can be reset. Initial or baseline readings are important since they are compared with subsequent detecting and measurements to detect a change in resonance of the resonator sensor. For waxes and gas hydrates, these materials could be removed by heating the sensor. Removal of asphaltenes and scale would be relatively more difficult, but in one non-limiting embodiment there could optionally be a solvent or acid wash line next to the resonator sensor to remove these chemical species.

“Measuring” is defined herein to encompass the simple detection of the presence of a material, e.g. chemical species (in a non-limiting instance, asphaltenes) regardless of amount, but also encompasses detection and/or measurement of the amount of a chemical species or other material. In another non-limiting embodiment, detecting the change in resonance of the resonator sensor involves measuring a baseline reading of the resonator sensor where the resonator sensor is free of chemical species deposition thereon, then measuring a subsequent reading of the resonator sensor, and comparing the baseline reading with the subsequent reading to detect deposition of a chemical species on the resonator sensor, where there is a change in sensor response not due to viscosity and/or density changes thereby indicating chemical species deposition.

“Monitoring” is defined herein to mean measurements on a basis that includes continuous, periodic, aperiodic, and/or intermittent measurements, which measurements can be at regular or irregular intervals.

One non-limiting goal would be to install the resonator sensor directly in the flow line or well. A challenge is that a sensor that protrudes into a flow line or well production tubing would be a hindrance to running pigs or running tools through the flow line or well. Another challenge would be that if the resonator sensor is placed too far away from the liquid flow, for instance in a recessed position from the flowline wall, that it may not accurately measure chemical species deposition. Thus, it is likely that different designs for sensor placement would be needed for optimal placement in different scenarios. In one non-limiting embodiment the surface of the resonator sensor upon which the chemical species may be deposited is essentially flush with the flow line, conduit or well.

In more detail, resonator sensors that measure changes in viscosity and/or density of a fluid may be used. It can also be important to measure the temperature of the fluid to obtain an accurate understanding of the changes in viscosity and/or density. Measuring the temperature can be done at any time during the method. In one non-limiting embodiment the resonator sensor should be highly accurate and provide reproducible inline measurements of both density and viscosity at process pressures up to 30,000 psi (2000 bar) and temperatures in excess of 400° F. (200° C.). A response time of about 1 second per reading permits monitoring of rapidly changing process parameters under conditions as extreme as ultra-deep oil, gas, and geothermal exploration and production, including measurement while drilling. Two specific, non-limiting examples are the DVP and DVM HPHT (high pressure, high temperature) density and viscosity sensors available from Rheonics, Inc.

In another non-limiting embodiment the resonator sensors are suitable for non-intrusive direct inline measurements in a pressure range from 2-12,500 mPa·s over a temperature range from −20 to 200° C. (−4 to 400° F.). These conditions may be considered HPHT in one non-limiting embodiment. The resonator sensors are unaffected by external vibrations and are able to measure a wide range of viscosities and densities, as well as detect deposition build-up on the sensor. The resonator sensors are also able to perform measurements in solid-laden fluids. Some resonator sensors have a density sensor and a viscosity sensor adjacent to each other, where each sensor may be operated independently and where the results show no influence from the adjacent complementary sensor. That is, when one sensor is operated, its characteristics were independent of the presence or absence of its adjacent sensor. Further, these resonator sensors have extremely low orientation sensitivity and thus are not limited to horizontal or vertical positions.

The resonator sensors have a resonant frequency and/or damping that is responsive to fluid density and/or fluid viscosity, which alter their resonant frequency. Thus, detecting a change in the resonance of the resonator includes measuring a parameter including a resonant frequency, a resonant frequency shift, and/or damping. These parameters are then correlated to fluid physical properties, including viscosity change and/or density, where the correlation is selected from the group consisting of a mathematical model and/or an empirical calibration curve. Both of these correlation methods provide extremely accurate and repeatable results, but because the empirical calibration method is less computationally expensive, it is the preferred one. It will be appreciated that deposition of material onto the sensor will affect the measurements. Conversely, in the absence of material depositing onto the sensor, the correlations are very accurate. The damping is a product of density and viscosity, thus if the density is affected, the viscosity is also. The density is calculated from the resonance frequency. From the damping and density (determined independently from resonance frequency), viscosity is determined.

Relevant patent documents related to resonator sensors and how they operate include, but are not necessarily limited to, U.S. Pat. Nos. 4,920,787; 5,837,885; 7,691,570; 8,291,750; 8,752,416; 9,267,872; 9,518,906, and 9,995,666; all of which are incorporated herein by reference in their entireties. Some of these resonator sensors are also called “tuning fork” resonators because the sensor employs a physical structure that resembles a tuning fork.

In one non-limiting embodiment the chemical species or foulant(s) within the petroleum-based fluid may range from about 0.01 wt % independently to about 30 wt %, or alternatively from about 0.1 wt % independently to about 10 wt % based on the organic or aqueous fluid in which they are present. The foulants may be or include, but are not limited to, asphaltenes, waxes, scales, gas hydrates, naphthenic acid salts, iron sulfides, coke, and combinations thereof.

It will be appreciated that the benefits of the method described herein include one or more of the following, but possibly others as well. (1) The method can detect whether deposition is occurring at a particular location. (2) The method can obtain information on the rate and/or severity of the deposition. (3) The method can gauge whether an inhibitor may help prevent or reduce deposition.

Preliminary deposition species would include, but not necessarily be limited to, asphaltenes and waxes from petroleum and scale from produced water. Other potential deposition monitoring could be in refineries, such as for asphaltenes, coke, and di-olefin reaction products. Also, detecting gas hydrate deposition could also be practiced with this method, although most gas hydrate blockages are from agglomeration and plugging from the agglomerates rather than deposition build up.

It should be noted that the term “independently” as used herein with respect to a range means that any lower threshold may be combined with any upper threshold to give a suitable alternative range.

The invention will be further described with respect to the following Examples, which are not meant to limit the invention, but rather to further illustrate the various embodiments.

### Example 1

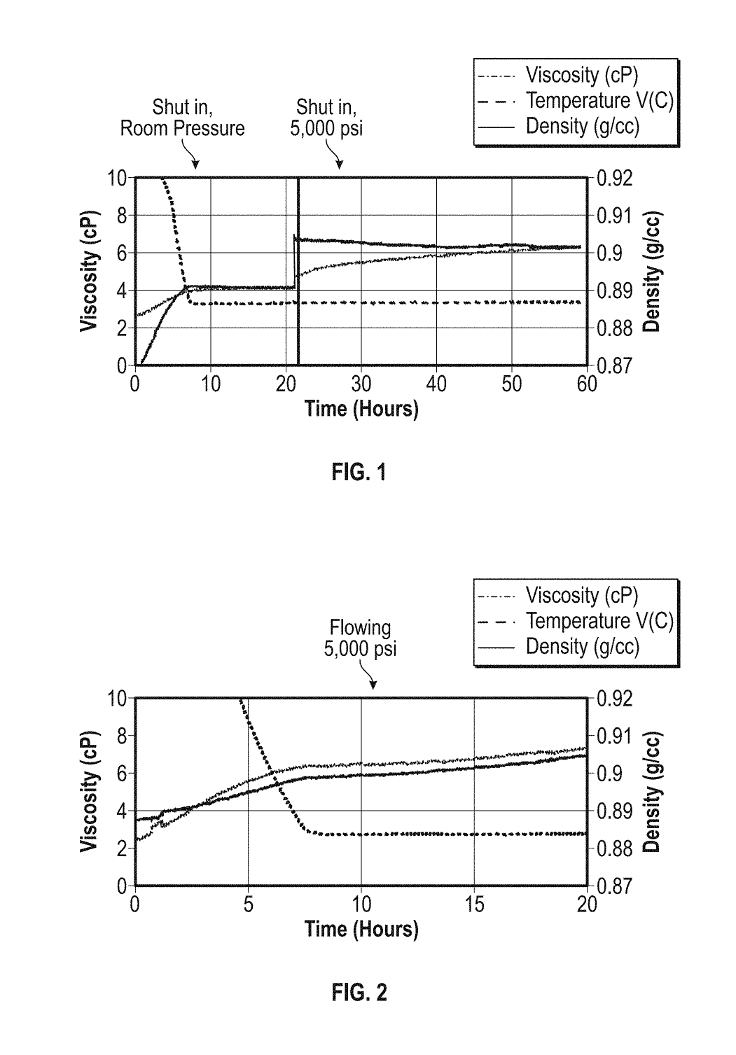

FIGS. 1 and 2 present viscosity and density measurements from a resonator sensor placed in a flow loop, using a sample wax-like polymer solution fluid (sample A).

In an experiment where the results are presented in FIG. 1, the experiment was performed under static conditions. At time=0, the fluid temperature was 30° C. As the fluid is cooled down to 3° C. over a period of 8 hours, both the viscosity and density of the fluid were observed to increase. Once the temperature reached a constant value, both the viscosity and density reached a constant value as well. At time about 21 hours, the pressure in the flow loop was raised to 5000 psi (34 MPa) maintaining the static conditions. An immediate jump in viscosity associated with the increase in pressure was observed, followed by a gradual increase which was consistent with the physical model of structure formation. The density however shows a sudden increase upon pressurization, followed by a constant plateau.

For the results presented in FIG. 2, the same experiment was conducted using the same wax-like polymer solution sample (sample A), this time performed under flowing conditions. At time=0, the fluid temperature was 30° C. and the system was pressurized to 5000 psi (34 MPa). As the fluid was cooled down to 3° C. over a period of 8 hours, both the viscosity and density of the fluid were observed to increase. After the temperature reached the set value, one would expect the viscosity to increase as observed in the previous experiment (FIG. 1 results) due to structure formation. However, the density was expected to stay constant if the temperature and pressure remain constant. With torsional resonators (resonator sensors), the density measurement is highly sensitive to the inertial mass of the resonators. Any deposition of material on the resonators will have an impact on the density measurement response. Therefore, an increase in the measured value for density without an actual fluid density increase is a clear indication of deposition on the tuning fork resonators. Moreover, by showing the difference between static and flowing conditions, the effect of volumetric throughput upon deposition has been shown. Under static conditions, there is essentially no deposition occurring because the amount of fluid in contact with the resonators is relatively small. During flow however, a significantly higher amount of fluid will come into contact with the resonators, thus increasing the amount of material that is deposited on the resonators over time. This fact is apparent from the recorded difference between the density trace between FIGS. 1 and 2. During static conditions, at 3° C. and 5000 psi (34 MPa), the density is essentially constant with time. During flow, at 3° C. and 5000 psi (34 MPa), the density is gradually increasing which indicates material buildup on the surface of the resonators.

### Example 2

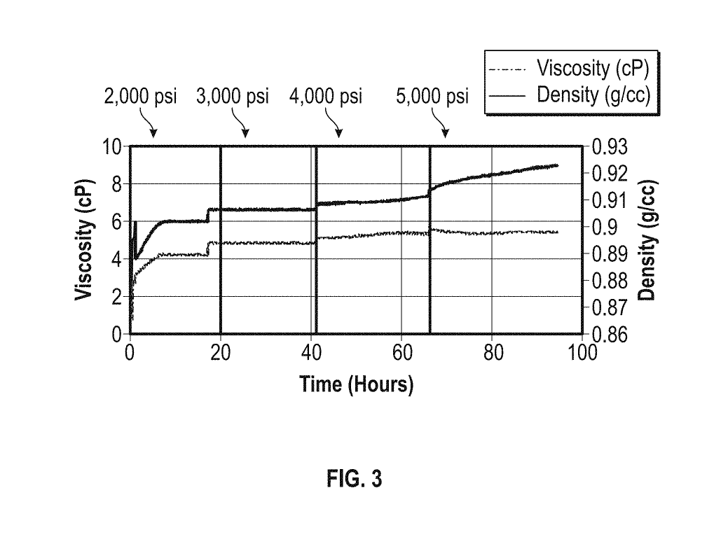

The results presented in FIG. 3 are from an experiment performed with a different sample of wax-like polymer solution (sample B). In this experiment, at time=0, the fluid temperature was 30° C. and the system was pressurized to 2000 psi (14 MPa) while keeping the flow rate constant at 4 ml/min, the pressure was subsequently increased to 3000 psi (21 MPa) at time=17 hours, 4000 psi (28 MPa) at time=41 hours and 5000 psi (34 MPa) at time=66 hours. After the initial cool down was complete at time=8 hours, both the measured density and viscosity remained constant until the pressure is increased to 3000 psi (21 MPa) at the 17 hour mark. At 3000 psi, both the measured density and viscosity remain constant as expected. At 4000 psi (28 MPa), after the initial jump in density, a gradual increase that accelerated as time progressed was observed. After the initial jump in viscosity, a gradual increase was observed that seemed to reach a plateau at the 60 hour mark. Just as shown in the example of FIG. 1 results, the gradual increase in measured density was indicative of deposition taking place caused by the pressure increase. At 5000 psi (34 MPa), both the density and viscosity anomalies observed at 4000 psi (28 MPa) seem to accentuate, which is indicative of more pronounced deposition taking place.

### Example 3

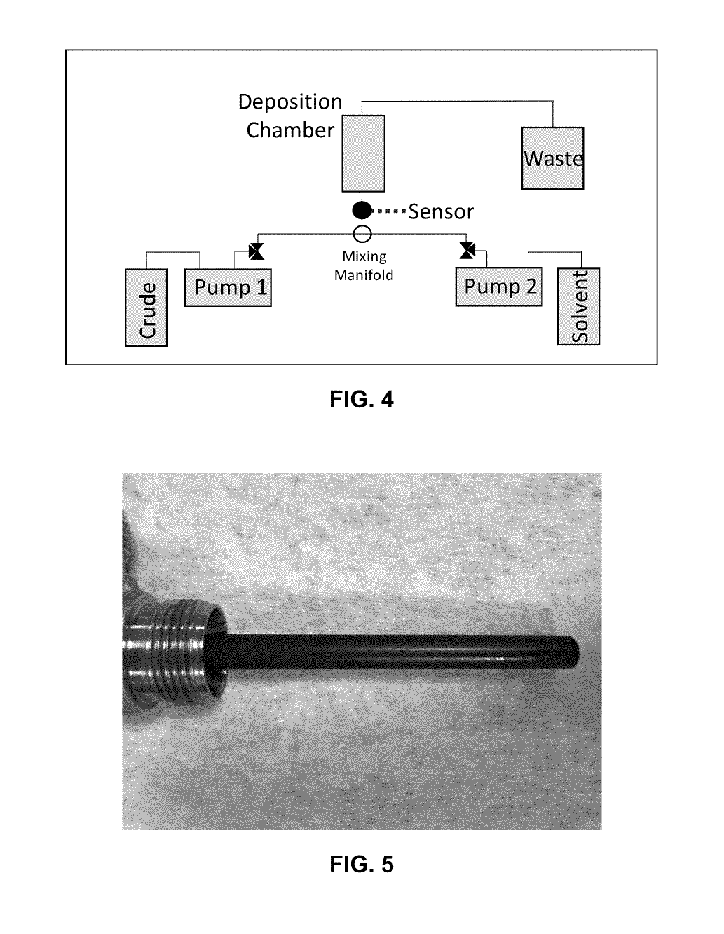

FIG. 4 shows a schematic of an apparatus designed to measure asphaltene deposition from dead crude oils caused by addition of a destabilizing solvent. The apparatus was designed for working with dead crude oils due to: (1) significant increased complications of testing with live fluids and (2) difficulties and costs in obtaining live crude oil samples. Although further removed from actual conditions within wells, the simplified dead crude oil testing can provide relative information on deposition tendencies of crude oils.

As defined herein “dead crude oil” refers to crude oils depressurized to atmospheric pressure containing no dissolved gas species within the crude oil. In contrast, “live” crude oils are at elevated pressure and still contain dissolved gas within the liquid-phase crude oil. This is the state of crude oil during production coming from a reservoir into a well and subsequent flowlines. Complete depressurization and liberation of all dissolved gas species typically does not occur until crude oil production passes through a series of high to low pressure separators at a host processing facility.

In the apparatus of FIG. 4, crude oil and destabilizing solvent are pumped separately into a mixing manifold to provide rapid mixing of the two fluids. Afterwards, the blended fluid mixture passes through a torsional resonator viscosity/density sensor (in Example 3 this was a Rheonics DVP in-line process density/viscosity meter) and then into a depositional chamber. For the data presented below, the deposition chamber consisted of a ¼″ (0.6 cm) OD stainless steel rod inserted into a ½″ (1.3 cm) OD stainless steel tubing. The length of the chamber was approximately 4 inches (10.2 cm). The crude oil/solvent fluid passed through the annular space between the rod and tubing and deposited asphaltenes on the outer surface of the ¼″ (0.6 cm) rod and inner surface of the ½″ (1.3 cm) tubing. The amount of total deposition in the deposition chamber was visually inspected and quantified after an experiment was completed. A procedure with a fluid displacement/flush and solvent wash/evaporation processes was used to collect and quantify the asphaltene.

During the course of the experiment, the torsional resonator viscosity/density sensor placed immediately before the deposition chamber can detect deposition trends occurring. Example 3 shows results from a deposition test. The deposition mass was much smaller on the sensor and therefore not typically measured. However, the deposition mass was measured for Example 3.

### Table A

### Example 3 Test Conditions

Crude Oil: Gulf of Mexico (GOM) Crude Oil #1
Destabilizing Solvent: Decane
Pump rates: 4 ml/min Decane and 2 ml/min Crude Oil
Duration: 331 minutes
Temperature: Room temperature ˜19-20° C.

### Results

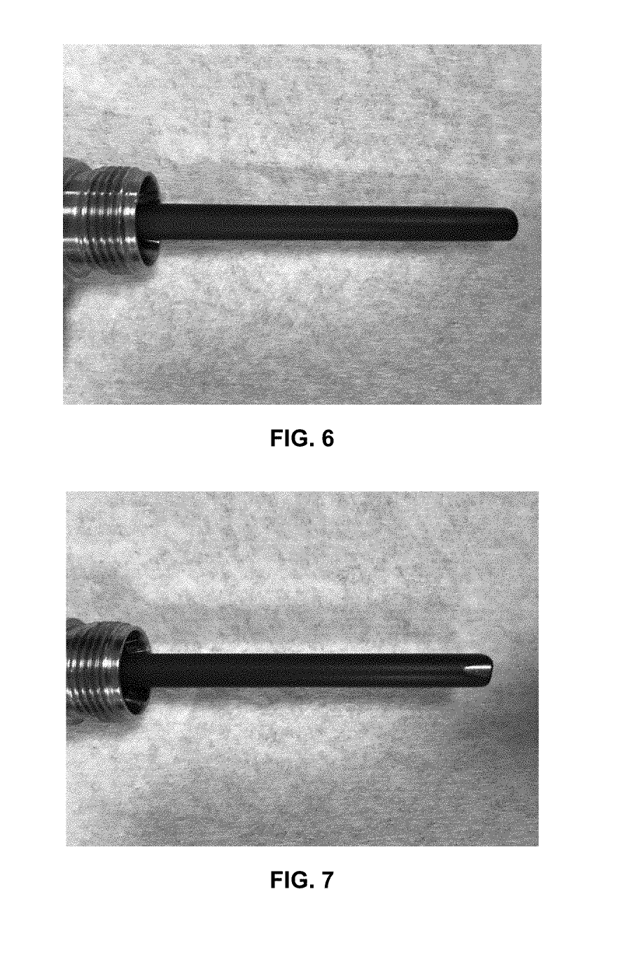

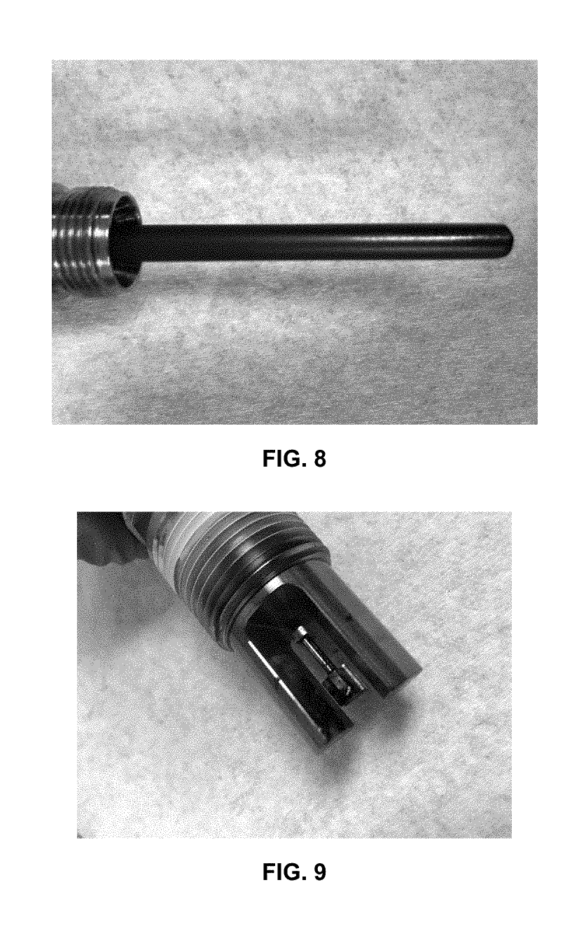

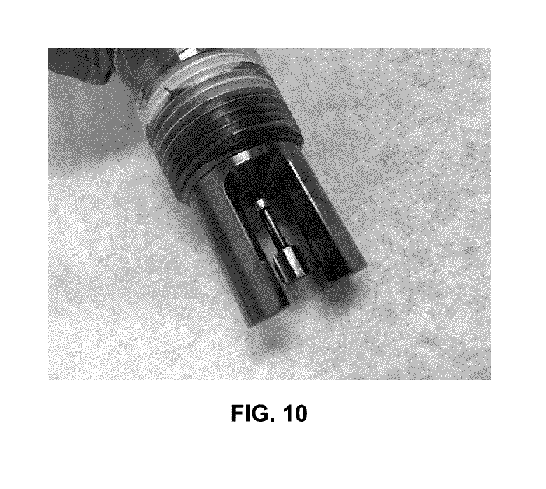

Clear asphaltene deposition was detected after the conclusion of the test with disassembly of the deposition chamber and removal of the torsional resonator from the custom fitting holding it in the apparatus flow path. FIGS. 5-8 and 9-10 show the asphaltene deposits formed on the inner rod of the deposition chamber and the resonator and resonator side walls. Coverage on the resonator was less uniform as the flowpath in the assembly favored flow only along the bottom of the sensor tines. As seen in FIGS. 9 and 10, deposition was more prominent on the bottom front face seeing entry flow. Note that the deposits were gently blown with nitrogen and rinsed with cyclohexane to remove any surface crude oil/decane from the deposits. Hence, the deposits shown are hard asphaltene deposit material and not residual crude oil. The small scrapped portion in FIG. 7 shows the difference between bare stainless metal and asphaltene deposited coated metal surface.

The weights of asphaltene deposits measured on the deposition chamber and resonator are presented in Table B.

### Table B

### Deposit Weights

Asphaltene Deposition Weight from Deposition Chamber: 0.0077 g
Asphaltene Deposition Weight on Sensor and Sensor side-walls: 0.0003 g

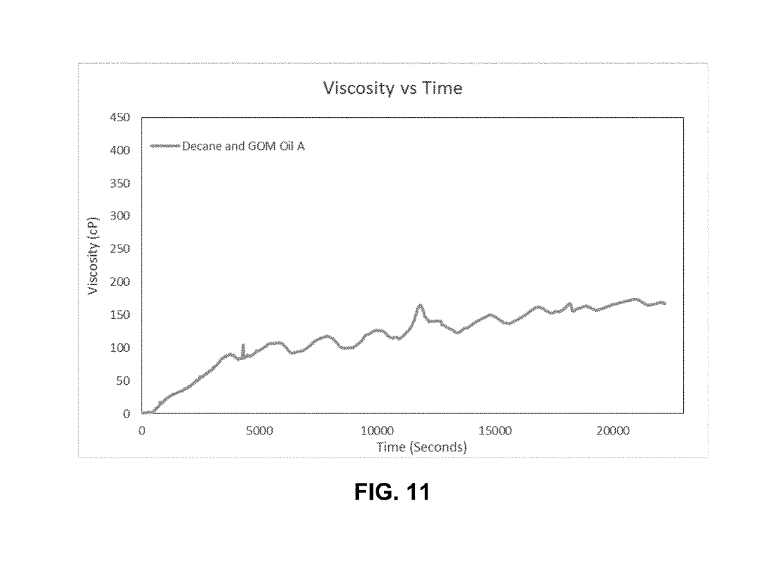

During the testing the torsional resonator detected the occurrence of deposition. In this test, the change in viscosity measurement showed the most significant effect (see FIG. 11). As continual fresh fluid (crude oil/decane) was pumped in a single pass through the apparatus no viscosity change was occurring. However, the torsional resonator sensor detected a change in excess of 160× the starting value for the measurement of viscosity. As no viscosity change occurred, the change in signal measurement was due to asphaltene deposition build-up on the sensor.

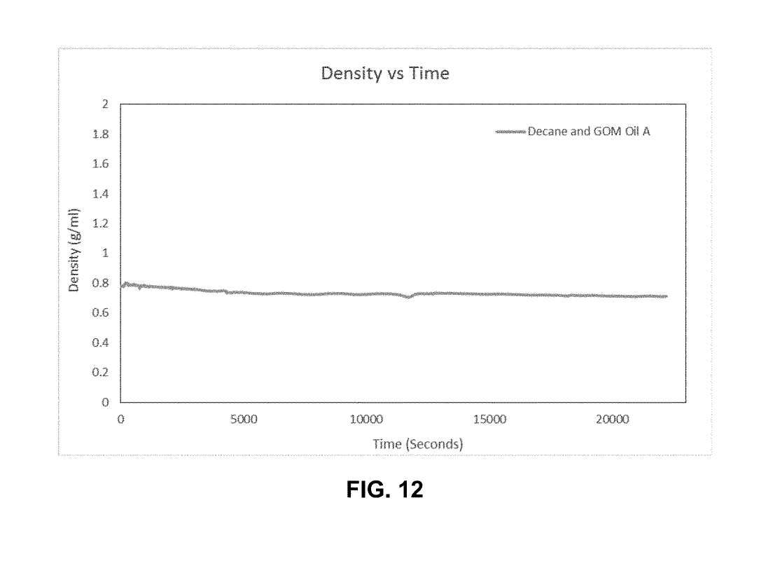

It should be noted that one would expect that the density measurement should also increase over time. However, in this test and others that have been run so far, the density has been relatively steady (see FIG. 12) or slight density decreases were observed. Without wanting to be bound by any particular explanation, the inventions believe that these results may be an artifact of the flowpath in which the sensor was installed. There is significant dead volume above the direct flowpath of fluid under and along the bottom of the sensor tines. It is believed that the slight decrease (shown in FIG. 12 for Example 3) is simply due to the density of fluid in the “dead space” decreasing over the course of the experiment due to slow asphaltene precipitation. It is believed that this can be corrected by making a different holder and changing the flowpath to go into the top and then down along the sensor shafts and tines, but these changes have not yet been made.

In the foregoing specification, the invention has been described with reference to specific embodiments thereof, and has been described as effective in providing methods for determining the stability of at least one foulant and/or relative efficacy of foulant inhibitor within a petroleum-based fluid sample. A particular advantage of the method described herein is that the chemical species deposition may be detected and/or measured while the fluid is flowing through the flow line, conduit, or well. However, it will be evident that various modifications and changes can be made thereto without departing from the broader scope of the invention as set forth in the appended claims. Accordingly, the specification is to be regarded in an illustrative rather than a restrictive sense. For example, specific petroleum-based fluids, other organic fluids, aqueous fluids, resonator sensors, torsional resonators, symmetrical sensors, flow lines, chemical species, foulants, foulant inhibitors, temperatures, pressures, time periods, falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of a method for measuring chemical species deposition in a well, flow line, or processing equipment that consists essentially of or consists of monitoring a resonator sensor in a flow line or well having an organic and/or aqueous fluid flowing therethrough, where the resonator sensor is selected from the group consisting of a torsional resonator and a symmetrical sensor, and detecting a change in resonance of the resonator sensor indicating the deposition of a chemical species on the resonator sensor.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for measuring chemical species deposition in a well, flow line, or processing equipment comprising:
monitoring a resonator sensor in a well, flow line, or processing equipment having a fluid selected from the group consisting of organic fluids, aqueous fluids, and combinations thereof, flowing therethrough, where the resonator sensor is selected from the group consisting of a torsional resonator and a symmetrical sensor; and
detecting a change in resonance of the resonator sensor indicating the deposition of a chemical species on the resonator sensor.

2. The method of claim 1 where detecting a change in the resonance of the resonator comprises:
measuring a parameter selected from the group consisting of a resonant frequency, a resonant frequency shift, damping, and a combination thereof; and
correlating the parameter to a change selected from the group consisting of a viscosity change, a density change, and a combination thereof, where the correlation is selected from the group consisting of a mathematical model, an empirical calibration curve, and a combination thereof.

3. The method of claim 1 where the amount of change in resonance is detected over a time period and correlated to an amount of deposition of the chemical species on the resonator sensor.

4. The method of claim 1 where the fluid comprises petroleum and the chemical species is selected from the group consisting of asphaltenes, wax, scale, gas hydrates, naphthenic acid salts, and combinations thereof.

5. The method of claim 1 further comprising subsequently removing the chemical species from the resonator sensor.

6. The method of claim 1 where the fluid comprises petroleum and the detecting a change in resonance of the resonator sensor comprises indicating deposition of asphaltenes from the organic and/or aqueous fluid.

7. The method of claim 1 where the fluid comprises petroleum and the detecting a change in resonance of the resonator sensor comprises indicating deposition of wax from the organic and/or aqueous fluid.

8. The method of claim 1 where the fluid is an aqueous fluid that comprises produced water and the detecting a change in resonance of the resonator sensor comprises indicating deposition of scale from the aqueous fluid.

9. The method of claim 1 where the fluid comprises a mixture of petroleum, gas, and produced water and the detecting a change in resonance of the resonator sensor comprises indicating deposition of gas hydrates from the fluids.

10. The method of claim 1 further comprising:
monitoring the resonator sensor at a first time where the fluid has an absence of a foulant inhibitor to give a first measurement;
monitoring the resonator sensor at a subsequent, second time where the fluid comprises a foulant inhibitor to give a second measurement;
comparing the first measurement and the second measurement to determine the effectiveness of the foulant inhibitor.

11. The method of claim 1 where detecting the change in resonance of the resonator sensor comprises:
measuring a baseline reading of the resonator sensor where the resonator sensor is free of chemical species deposition thereon;
measuring a subsequent reading of the resonator sensor; and
comparing the baseline reading with the subsequent reading to detect deposition of a chemical species on the resonator sensor.

12. The method of claim 1 further comprising measuring the temperature of the fluid at any time in the method.

13. A method for measuring chemical species deposition in a well, flow line, or processing equipment comprising:
monitoring a resonator sensor in a well, flow line, or processing equipment having a fluid selected from the group consisting of organic fluids, aqueous fluids, and combinations thereof, flowing therethrough, where the resonator sensor is selected from the group consisting of a torsional resonator and a symmetrical sensor; and
detecting a change in resonance of the resonator sensor indicating the deposition of a chemical species on the resonator sensor, where the detecting comprises:
measuring a parameter selected from the group consisting of a resonant frequency, a resonant frequency shift, damping, and a combination thereof; and
correlating the parameter to a change selected from the group consisting of a viscosity change, a density change, and a combination thereof, where the correlation is selected from the group consisting of a mathematical model, an empirical calibration curve, and a combination thereof; and
where the amount of change in resonance is detected over a time period and correlated to an amount of deposition of the chemical species on the resonator sensor.

14. The method of claim 13 where the fluid comprises petroleum and the chemical species is selected from the group consisting of asphaltenes, wax, scale, gas hydrates, naphthenic acid salts, and combinations thereof.

15. The method of claim 13 further comprising subsequently removing the chemical species from the resonator sensor.

16. The method of claim 13 where the fluid comprises petroleum and the detecting a change in resonance of the resonator sensor comprises indicating deposition of asphaltenes from the organic and/or aqueous fluid.

17. The method of claim 13 where the fluid comprises petroleum and the detecting a change in resonance of the resonator sensor comprises indicating deposition of wax from the organic and/or aqueous fluid.

18. The method of claim 13 where the fluid is an aqueous fluid that comprises produced water and the detecting a change in resonance of the resonator sensor comprises indicating deposition of scale from the aqueous fluid.

19. The method of claim 13 where the fluid comprises a mixture of petroleum, gas, and produced water and the detecting a change in resonance of the resonator sensor comprises indicating deposition of gas hydrates from the fluids.

20. A method for measuring chemical species deposition in a well, flow line, or processing equipment comprising:
monitoring a resonator sensor in a well, flow line, or processing equipment having a fluid selected from the group consisting of organic fluids, aqueous fluids, and combinations thereof, flowing therethrough, where the resonator sensor is selected from the group consisting of a torsional resonator and a symmetrical sensor;
measuring the temperature of the fluid at any time in the method; and
detecting a change in resonance of the resonator sensor indicating the deposition of a chemical species on the resonator sensor, where the detecting comprises:
measuring a baseline reading of the resonator sensor where the resonator sensor is free of chemical species deposition thereon;
measuring a subsequent reading of the resonator sensor; and
comparing the baseline reading with the subsequent reading to detect deposition of a chemical species on the resonator sensor.
